(19) United States
(12) Patent Application Publication
(10) Pub. No.: US 2020/0406178 A1
(43) Pub. Date: Dec. 31, 2020

(54) PROCESS FOR FORMING POROUS FILTER MEDIA

(71) Applicant: Aqua Guidance Technologies, Ltd., Nassau (BS)

(72) Inventors: Symon Thomas, Brundall (GB); Andrew Lombardo, Pompano Beach, FL (US)

(21) Appl. No.: 16/915,157

(22) Filed: Jun. 29, 2020

Related U.S. Application Data
(60) Provisional application No. 62/868,885, filed on Jun. 29, 2019.

(51) Int. Cl. B01D 39/16; C02F 1/00; B01D 39/20

(52) U.S. Cl. CPC B01D 39/1661; C02F 1/004; B01D 2239/1216; B01D 2239/086; B01D 2239/10; B01D 39/2062

(57) ABSTRACT

Disclosed is a filter element from removing contaminants from water comprised of first filter media particles having a first particle size and second media particles having a second particle size and methods for making such a filter element. The first media particles are adhered to surfaces of the second media particles. A binder connects the second media particles with one another so that interstitial spaces are formed between second media particles. A portion of the smaller first filter media particles are positioned within the interstitial spaces. According to one embodiment of the disclosure water flows through the filter element at a flux greater than about 1.5 ml/min/cm² has a pressure drop less than 20 psi.

This application claims priority under 35 U.S.C. § 119 to U.S. Provisional Patent Application No. 62/868,885, filed on Jun. 29, 2019. The disclosure of that application is incorporated herein by reference.

### BACKGROUND

### Field

The present invention relates to filters and media for filters for removing substances from water. In particular, the present invention relates to processes and methods for forming a filter element from combinations of filter particles with a structure that provides voids and pathways for water to pass through the filter element while interacting with active surfaces of the filter element to remove substances from the water.

### Description of the Related Art

Water filters provide a means for removing contaminants from water that might otherwise render water unpalatable or unhealthy. One type of water filter relies on materials with an active surface that chemically or physically captures and holds contaminants. The lifetime of such a filter element may be limited by the amount of surface area available to absorb substances from water. Active regions on the surface of a filter element can hold only a finite amount of absorbed substance. Thus, it is advantageous to provide a filter element that has a large surface area with active sites to adsorb substances before becoming saturated.

In addition, the rate at which substances are removed from water passing through a filter may depend on the number of active sites on the surfaces of the materials forming the filter. Thus, it would be advantageous to provide a filter element where the active surface area of the filter material in contact with water flowing through the filter element is large to more rapidly capture contaminants.

In order to provide sufficient amounts of filtered water, a filter element needs to provide sufficient flow, while at the same time effectively removing harmful or unwanted substances from the water. Some known filter elements physically capture particulate contaminants by providing narrow pathways for water to flow. Contaminant particles larger than the width of the pathway are captured. Filter elements that rely on very narrow pathways to capture contaminants may provide a low flow rate and/or high pressure drop, making them unsuitable for certain applications.

One way to increase the amount of surface area available to adsorb contaminants is to provide a filter element composed of very fine particles. One problem with filter materials with a fine particle size is that the particles may adhere to one another. The agglomerated particles may reduce the rate water can flow through the filter material and/or increase the pressure drop across the filter element.

One way to increase the flow rate of water through filters is to provide water to the filter element under pressure. Pressure driven systems can provide improved flow rate by overcoming the pressure drop created when water flows through the narrow passages of the filter. Such systems may be connected to a pressurized water source, for example, a sink faucet. Pressure driven systems have the disadvantage that a pressure source must be provided, potentially adding cost and complexity. Filters that are plumbed to a municipal water source are not portable, may require professional installation, and can only be used in parts of the world equipped with a municipal water delivery system. Another alternative is to provide an electric or hand driven pump to generate pressure. Such systems may add complexity and cost, particularly in regions of the world that lack electrical service. In addition, where the filter is part of a portable water filtration system, pumps and other equipment add weight. This additional weight may be undesirable where the filter is used for outdoor sporting activities, e.g., backpacking.

### SUMMARY

The present disclosure relates to apparatuses and methods to address these difficulties.

Embodiments of present disclosure provide filter elements and methods for creating a filter element comprised of smaller particle size filter material combined with larger particle size material to capture contaminants. A filter element made according to embodiments of the disclosure may provide increased flow rate and/or a reduced pressure drop. According to some embodiments, such a filter element provides a sufficiently low pressure drop to function as a gravity fed filter.

According to some embodiments there is disclosed a method for forming a filter element comprising the steps of: providing first filter media particles having a first mean particle size; providing second filter media particles having a second mean particle size, wherein the second mean particle size is larger than the first mean particle size; forming a gluing solution, wherein the gluing solution comprises a vehicle, a non-thermoplastic adhesive, and a solubilizing agent; mixing second filter media particles with the first filter media particles and the gluing solution to form a filter media mixture; blending the gluing solution and filter media mixture to form a media blend; drying the blend, wherein a substantial portion of the vehicle is evaporated from the media blend; and decomposing the agent, wherein the non-thermoplastic adhesive binds the first filter media particles to surfaces of the second filter media particles. The solubilizing agent may enhance dissolution of the non-thermoplastic adhesive in the vehicle.

The non-thermoplastic adhesive may further comprise an adjunct that creates a negative electric charge when saturated with water. The non-thermoplastic adhesive may comprise one or more of polyvinylamine, poly(N-methylvinylamine), polyallylamine, polyallyldimethylamine, polydiallylmethylamine, polyvinylpyridinium chloride, poly (2-vinylpyridine), poly(4-vinylpyridine), polyvinylimidazole, poly(4-aminomethylstyrene), poly(4-aminostyrene), polyvinyl(acrylamide-co-dimethylaminopropylacrylamide), polyvinyl(acrylamide-co-dimethylaminoethylmethacrylate), polyethyleneimine, polylysine, poly diallyl dimethyl ammonium chloride (pDADMAC), poly(propylene)imine dendrimer (DAB-Am) and Poly(amidoamine) (PAMAM) dendrimers, polyaminoamides, polyhexamethylenebiguandide, polydimethylamine-epichlorohydrine, aminopropyltriethoxysilane, N-(2-aminoethyl)-3-aminopropyltrimethoxysilane, N-trimethoxysilylpropyl-N,N,N-trimethylammonium chloride, bis(trimethoxysilylpropyl)amine, chitosan, grafted starch, the product of alkylation of polyethyleneimine by methylchloride, the product of alkylation of polyaminoamides with epichlorohydrine, cationic polyacrylamide with cationic monomers, and combinations thereof.

The vehicle may comprise one or more of water, methanol, ethanol, n-propanol, n-butanol, acetone, ethyl acetate, methyl acetate, dimethyl sulfoxide, acetonitrile, dimethylformamide, chloroform, and combinations thereof.

The solubilizing agent may comprise one or more of hydrochloric acid, sulfuric acid, nitric acid, phosphoric acid, tartaric acid, acetic acid, formic acid, propionic acid, ascorbic acid, glutamic acid, lactic acid, maleic acid, malic acid, succinic acid, carboxylic acid, and combinations thereof.

One or more of the steps of drying and decomposing may comprise exposing the blend to an elevated temperature while agitating the blend, wherein the blend forms a flowable blend.

One or more of the steps of drying and decomposing may be performed while the blend is stationary to form a solid mass, and may further comprise granulating the mass by one or more of crushing, grinding, or sieving to form a flowable blend.

The first filter media particles may comprise lignite, anthracite, bituminous coal, peat, carbonized wood organic material including bamboo, coconut husk, and animal bone, zeolite including analcime, leucite, pollucite, wairakite, clinoptilolite, barrerite, chabazite, phillipsite, amicite, and gobbinsite, calcium compound including monocalcium phosphate, dicalcium phosphate, monetite, brushite, tricalcium phosphate, whitlockite, octacalcium phosphate, dicalcium diphosphate, calcium triphosphate, hydroxyapatite, apatite, tetracalcium phosphate, diatomaceous earth, silicon compounds including glass, expanded glass, pumice, ceramic material including alumina, bauxite, magnesia, titanium dioxide, and combinations thereof.

The second filter media particles may comprise lignite, anthracite, bituminous coal, peat, carbonized wood organic material including bamboo, coconut husk, and animal bone, zeolite including analcime, leucite, pollucite, wairakite, clinoptilolite, barrerite, chabazite, phillipsite, amicite, and gobbinsite, calcium compound including monocalcium phosphate, dicalcium phosphate, monetite, brushite, tricalcium phosphate, whitlockite, octacalcium phosphate, dicalcium diphosphate, calcium triphosphate, hydroxyapatite, apatite, tetracalcium phosphate, diatomaceous earth silicon compounds including glass, expanded glass, pumice, ceramic material including alumina, bauxite, magnesia, titanium dioxide, and combinations thereof.

The first mean particle size may be between about 1 and about 75 um. The second mean particle size may be between about 75 and about 3000 um.

The first filter media particles and second filter media particles may be porous and have a total porosity greater than about 0.5 cc/g. Greater than 40% of the total porosity may be provided by pores with a pore size greater than about 5 nanometers.

According to one aspect the method further comprises providing a binder; mixing the flowable blend with the binder; and forming the flowable blend and binder into a solid filter element.

The present disclosure provides other embodiments of a filter element and a method for creating a filter element that uses combinations of porous particles to provide increased surface area due to their internal pore volume, where the particles form voids that allow influent water to flow through the filter in contact with the porous material to remove contaminants.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a flow chart illustrating a method for forming a filter media according to an embodiment of the disclosure;

FIG. 2 is a photomicrograph showing a portion of a filter element according to an embodiment of the disclosure;

FIG. 3 is a diagram showing an apparatus for measuring a pressure drop and flow rate through a filter according to an embodiment of the disclosure;

FIG. 4 is a graph showing the flow rate and pressure drop across a filter formed according to an embodiment of the disclosure: and

FIG. 5 is a graph showing the particle size distribution of materials used to form filter media according to an embodiment of the disclosure.

### DETAILED DESCRIPTION

The present disclosure provides embodiments of a filter element and of filter media and methods for forming a filter media and filter elements that reduces the concentration of contaminants in water, while providing a high flow rate or flux and low pressure drop.

According to one embodiment, a filter media is prepared by adhering smaller particle size material to the surfaces of larger particle size material and then binding the combined particles into a filter element. A filter element formed according to the disclosure includes voids between the larger particles to allow water to flow. The smaller particles adhered to the surfaces of the larger particles interact with water flowing through the voids to remove contaminants from the water.

According to a further embodiment, a gluing solution is prepared by dissolving a non-thermoplastic adhesive material in a solvent. Smaller particle size material and larger particle size material are mixed together, and the gluing solution is added to the mixture. The solvent is decomposed and driven from the mixture while the mixture is agitated so that the non-thermoplastic adhesive binds the smaller particles to the surfaces of the larger particles while the larger particles remain substantially separate from one another. The result is a filter media that is flowable. A surprising result of filter media formed according to the disclosed embodiments is that, where the smaller and/or the larger particle size materials are porous, these materials maintain a substantial portion of their effective pore volumes after having been bound together. By preserving the porosity of the materials, the amount of surface area available to adsorb contaminants is maintained.

According to a further embodiment, a filter element is formed using the flowable filter media prepared as described above. The filter media is mixed with thermoplastic resin in the form of a powder, pellets or granules. The mixture is placed in a mold cavity. Heat and pressure are applied so that the resin melts. The mold is allowed to cool so that the resin solidifies, joining the larger particles or granules with one another in an open spaced structure.

According to one preferred embodiment, the smaller particle size material comprises particles with a mean diameter (D50) of between 1 microns and 180 microns. According to a more preferred embodiment, the smaller particle size material comprises particles with a mean diameter (D50) of between 10 microns and 75 microns. According to a most preferred embodiment, the smaller particle size material comprises particles with a mean diameter (D50) of about 15 microns.

Particle size may be determined using techniques known to those of ordinary skill in the field of the disclosure. According to some embodiments, particle size is determined by a laser light scattering technique using an instrument such as Partica LA-960 Laser Scattering Particle Size Distribution Analyzer, manufactured by Horiba, Ltd.

A commonly used metric when describing particle size distributions are D-Values (D10, D50 & D90) which are the intercepts for 10%, 50% and 90% of the cumulative mass. The smaller particle size material according to one embodiment of the disclosure was analyzed to determine its D10/D50/D90 size profile. According to one embodiment, the material had a D10 of about 6 microns, a D50 of about 15 microns and a D90 of about 47 microns.

According to a further embodiment of the disclosure, the, the smaller particle size material is analyzed using sieves according to methods know in the field of the invention so that particles within a specified range are selected. According to a preferred embodiment, the smaller particle size material has particles that are less than about 80 mesh. According to a more preferred embodiment, the smaller particle size material has particles that are less than about 100 mesh. According to a most preferred embodiment, the smaller particle size material has particles that are less than 325 mesh

According to another embodiment, the larger particle size material comprises particles with a mean diameter (D50) of between 75 microns and 3000 microns. According to a preferred embodiment, the larger particle size material comprises particles with a mean diameter (D50) of between 100 microns and 2000 microns. According to a most preferred embodiment, the larger particle size material comprises particles with a mean diameter (D50) of about 1500 microns. According to another embodiment, the D10/D50/D90 size distribution of the larger particle size material had a D10 of 770 microns, a D50 of 1310 microns and a D90 of about 2230 microns.

According to one embodiment, the smaller particle size material is formed from particles with a mean diameter significantly less than the size of the larger particle size material. The relative sizes of the particles may be selected so that when the open spaced structure of the filter element is formed, the smaller particle size material is positioned within interstitial spaces formed between particles of the larger particle sized material and the interstitial spaces remain open to allow water to flow through the element. According to a preferred embodiment, the mean particle size of the larger particle size component is between about 1× and 200× larger than the smaller particle size material. According to a more preferred embodiment, the mean particle size of the larger particle size component is between about 5× and 150× the size of the smaller particle size component. According to a most preferred embodiment, the mean particle size of the larger particle size component is about 100× larger than the smaller particle size component.

As discussed in co-pending U.S. Provisional Patent Appl. No. 62/868,883, filed on Jun. 29, 2019 and U.S. patent application Ser. No. ______, filed (Attny. Docket No. 250-0002US), which are incorporated herein by reference, by providing porous filter particles where pore volume is provided primarily from epipores, that is, mesopores and macropores, with a pore size above about 5 nm, a filter that effectively removes substances such as organic acids from water may be created. According to one embodiment of the present disclosure, the smaller particle size material and/or the larger particle size material are porous and, before being formed into a flowable filter media, have a specific total pore volume measured by ATSM method D 6556:2017-11 utilizing BJH interpolation, showing preferably between about 0.4 cc/g measured and about 3.0 cc/g, more preferably from about 0.8 cc/g to about 1.8 cc/g, and most preferably between about 1.2 cc/g and 1.6 cc/g. According to a preferred embodiment, greater than about 40% of the pore volume is contributed by epipores, more preferably greater than about 50% contributed by epipores, and still more preferably greater than about 60% contributed by epipores. According to a most preferred embodiment, greater than about 65% of the total pore volume is contributed by epipores. According to another embodiment, a filter media according to the disclosure has a total pore volume of 0.545 g/cc with about 41% of that volume contributed by epipores.

According to an embodiment of the disclosure, when smaller particle size material and larger particle size material are mixed with a gluing solution and the solvent is eliminated from the mixture so that the smaller particle size material is bound to the surfaces of the larger particle size material by the non-thermoplastic adhesive, the pores of one or both of the materials remain open so that a significant portion of the pore volume is retained after being glued together with the non-thermoplastic adhesive. According to a preferred embodiment, the total pore volume of the smaller particle size and larger particle size material after gluing is greater than 30% of the pore volume of the materials before the particles are glued. According to a more preferred embodiment, the total pore volume of the smaller particle size and larger particle size material after gluing is greater than 35% of the pore volume of the materials before the particles are glued. According to a most preferred embodiment, the total pore volume of the smaller particle size and larger particle size material after gluing is greater than 45% of the pore volume of the materials before the particles are glued.

Porous larger particle size material and smaller particle size material may be formed from carbon compounds such as, but not limited to, lignite, anthracite, or bituminous coal, peat, oil, tar, carbonized organic matter such as wood, bamboo, coconut husk, or bone, from zeolite particles such as, but not limited to, analcime, leucite, pollucite, wairakite, clinoptilolite, barrerite, chabazite, phillipsite, amicite, or gobbinsite, from a calcium compound such, as but not limited to, monocalcium phosphate, dicalcium phosphate, monetite, brushite, tricalcium phosphate, whitlockite, octacalcium phosphate, dicalcium diphosphate, calcium triphosphate, hydroxyapatite, apatite, tetracalcium phosphate, from silicon containing materials including, but not limited to, diatomaceous earth, glass, pumice, and the like.

According to a further embodiment, the non-thermoplastic adhesive material be combined with an adjunct that creates an electric field when saturated by water. According to another embodiment, the non-thermoplastic adhesive may itself include moieties that creates such a field. According to one embodiment, these substances or moieties create an effective negative charge (i.e., they are cationic). The non-thermoplastic adhesive may be formed from or may be mixed with monomers or polymers that include, but are not limited to, polyvinylamine, poly(N-methylvinylamine), polyallylamine, polyallyldimethylamine, polydiallylmethylamine, polyvinylpyridinium chloride, poly (2-vinylpyridine), poly(4-vinylpyridine), polyvinylimidazole, poly(4-aminomethylstyrene), poly(4-aminostyrene), polyvinyl(acrylamide-co-dimethylaminopropylacrylamide), polyvinyl(acrylamide-co-dimethylaminoethylmethacrylate), polyethyleneimine, polylysine, poly diallyl dimethyl ammonium chloride (pDADMAC), poly(propylene)imine dendrimer (DAB-Am) and Poly(amidoamine) (PAMAM) dendrimers, polyaminoamides, polyhexamethylenebiguandide, polydimethylamine-epichlorohydrine, aminopropyltriethoxysilane, N-(2-aminoethyl)-3-aminopropyltrimethoxysilane, N-trimethoxysilylpropyl-N,N,N-trimethylammonium chloride, bis(trimethoxysilylpropyl)amine, chitosan, grafted starch, the product of alkylation of polyethyleneimine by methylchloride, the product of alkylation of polyaminoamides with epichlorohydrine, cationic polyacrylamide with cationic monomers, dimethyl aminoethyl acrylate methylchloride (AETAC), dimethyl aminoethyl methacrylate methyl chloride (METAC), acrylamidopropyl trimethyl ammonium chloride (APTAC), methacrylamidopropyl trimethyl ammonium chloride (MAPTAC), diallyl dimethyl ammonium chloride (DADMAC), ionenes, silanes and combinations of these compounds. The adhesive may further comprise compounds that render a surface including the adhesive cationic such as quaternary ammonium compounds such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride and domiphen bromide, and combinations of these compounds.

According to one embodiment of the disclosure the solvent includes a vehicle that is suitable for dissolving the selected adhesive and that can be volatilized and removed from the mixture by evaporation. Such vehicles include, but are not limited to, water, methanol, ethanol, n-propanol, n-butanol, acetone, ethyl acetate, methyl acetate, dimethyl sulfoxide, acetonitrile, dimethylformamide, chloroform, and the like.

According to another embodiment of the disclosure, the solvent includes an agent to enhance the solubility of the adhesive in the vehicle. The vehicle can be driven off from the material by heating and the agent can be thermally decomposed when heated to a selected temperature to deposit the adhesive on particle surfaces. Suitable agents include, but are not limited to hydrochloric acid, sulfuric acid, nitric acid, phosphoric acid, tartaric acid, acetic acid, formic acid, propionic acid, ascorbic acid, glutamic acid, lactic acid, maleic acid, malic acid, succinic acid, carboxylic acid, and combinations thereof. Not wishing to be bound by theory, it is surmised that when a gluing solution formed with a solvent according to this embodiment is mixed with larger particles size material and smaller particle sized material and the mixture is heated to evaporate some or all of the vehicle, the adhesive remains solubilized by the agent in a liquid or semiliquid state and coats the particles. Heating causes the agent to decompose, solidifying the adhesive on the surfaces of the particles and affixing the smaller particles to surfaces of the larger particles.

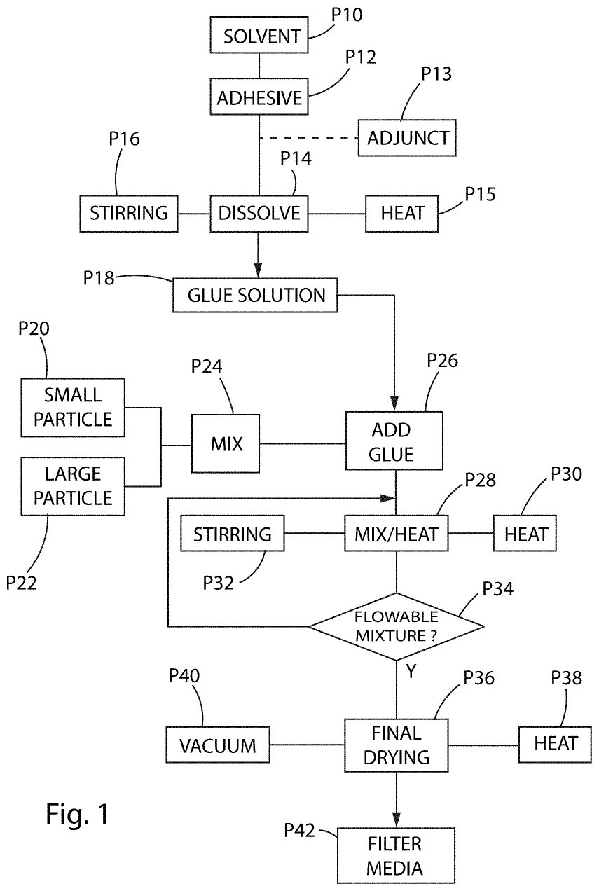

FIG. 1 shows a flow chart illustrating the steps for forming a filter media according to an embodiment of the disclosure. At step P10, a suitable solvent is obtained, and a selected amount needed to form the filter media is measured. The solvent may include a vehicle, for example, water and an agent. At step P12, a suitable non-thermoplastic adhesive is obtained, and a selected amount needed to form the filter media is measured. Optionally, at step P13, other adjuncts may be added, for example, quaternary ammonium compounds that provide a charged surface when the finished filter media is saturated by water. At step P14, the solvent, adhesive, and adjuncts are mixed in a container and the adhesive is dissolved in the solvent. To promote the dissolution of the adhesive in the solvent, heat may be applied at step P15, for example, by placing the mixing container on a hot plate. Stirring may be provided at step P16, for example, by a magnetic stirring bar in the mixing container coupled to a stirrer within the hot plate. To reduce the evaporation of solvent while the adhesive is dissolved, the mixing container may be substantially closed and surmounted by a reflux condenser. Once the adhesive is completely dissolved in the solvent, the finished gluing solution is stored at step P18.

At step P20 smaller particle size material is obtained, and a selected amount needed to form the filter media is measured. The smaller particle size material may be tested to determine its specific total pore volume and its pore size distribution, using, for example, BET porosimetry and/or tested to determine its particle size distribution. At step P22, larger particle size material is obtained, and a selected amount needed to form the filter media is measured. The larger particle size material may be tested to determine its specific total pore volume and its pore size distribution, using, for example, BET porosimetery and/or tested to determine its particle size distribution. According to one embodiment, as part of steps P20 and/or P22 the particles sizes of the materials may be modified by grinding and/or classified by sieving to provide a specific mean particle size and/or sieve range. At step P24, the smaller and larger particle size materials are mixed, for example, in a stand mixer or ribbon blender.

When the materials have been mixed to form a homogeneous mixture, at step P26 the gluing solution is added to the stand mixer or ribbon blender to form a paste. At step P28, the paste is stirred and heat is applied, as shown in steps P30 and P32. Heat may be applied by a heating jacket affixed to the container of the stand mixer or ribbon blender. As solvent is driven from the paste, the smaller particles adhere to the surfaces of the larger particles and the larger particles remain separate from one another to create a flowable blend. If the solvent includes an agent that is thermally decomposable, a substantial portion of the vehicle is first removed while the adhesive remains in a liquid or semi-liquid state and coats the smaller and larger particles. At step P34 the blend is evaluated to determine whether almost all of the solvent, or the vehicle component of the solvent, has been driven off and that the mixture forms a flowable granular media. Mixing and heating is continued at step P28 until substantially all the solvent has been driven from the blend, the agent has been decomposed, and the mixture has a flowable consistency. The media is then placed in a drying oven at step P36 and heat is applied at step P38 to further decompose the agent and to drive the remaining vehicle from the mixture. To facilitate the removal of any remaining solvent, vacuum may be applied at step P40. The final dried blend forms the filter media at step P42.

An alternative method for forming a filter media according to an embodiment of the disclosure may also be used. The method is the same as described above with respect to FIG. 1, except that, at step P28 instead of mixing the material while heat and/or vacuum are applied to drive off the solvent and form a flowable blend, the mixture is placed in a stationary container, such as a mold cavity, and the solvent is driven from the mixture and the material forms solid lumps. The lumps are placed in an oven at step P36 for a final drying step and then fractured, crushed, ground, or otherwise broken into granules of a desired particle size. The granules may be analyzed to create a desired particle size distribution, for example, using sieves with various size openings to select a desired size range.

According to one embodiment, the filter material is provided as a loose bed. The bed of material may be contained in a housing having an inlet and an outlet with a mesh across the outlet to hold the material in the housing while water to be filtered flows through the bed of material. According to another embodiment, the filter material is immobilized into a solid structure in the form of a puck, block, cylinder, or the like. One such filter is described in co-pending U.S. patent application Ser. No. 16/176,398, filed Oct. 31, 2018, which is incorporated herein by reference.

Particles forming the filter may be immobilized by providing a binder to the mixture of particles. The binder joins adjacent particles to one another to form a solid filter. The binder may be a thermoplastic polymer such as polyethylene, polycarbonate, polyvinylchloride, polyamideimide, polyetherimide, polyarylate, polysulphone, polyamide, polymethylmethacrylate, acrylonitrile butadiene styrene, polystyrene, polyetheretherketone, polytetrafluoroethylene, polyamide 6,6, polyamide 11, polyphenylene sulphide, polyethylene terephthalate, polyoxymethylene, polypropylene, polydimethyl siloxane, polyoxymethylene, polyethylene terephthalate, polyetheretherketone, nylon 6, polysulphone, polyphenylene sulphide, polyethersulphone, and the like. According to a preferred embodiment, the binder is Ultra High Molecular Weight Polyethylene (UHMWPE).

To form a filter puck or other solid filter element, the binder is added to a mixture of smaller and larger particle size material, such as the filter media formed at step P42 shown in FIG. 1. The binder may be in the form of resin particles, pellets, or granules. The mixture is placed in a mold and subject to an elevated temperature to melt the polymer. Pressure may be applied to the mold to force the material to conform to the mold cavity to shape the filter material into a suitable configuration. When the material cools the polymer hardens, joining the particles into a porous, solid, immobile filter element. The filter element is then assembled in a housing that provides a path for raw, untreated water to flow through the filter material. According to another embodiment, instead of shaping the material in a mold cavity, the filter media and the binder are mixed and then is heated to liquefy the polymer. This mixture is forced through an extrusion die to form an extruded body. The extruded body is then cut to a length suitable to form a filter element.

According to one embodiment, the material may be formed into a filter element with one of a variety of shapes, for example, a cylinder, a polygonal prism, a cone or truncated cone, and the like. The filter element may be arranged so that inffluent flows into the element through one face. The filter element may have a thickness between about 1 cm and 10 cm and a surface area of the face between about 30 cm² and 60 cm². The ratio of the thickness of the filter element to its facial area may be between about 0.017 cm⁻¹ and 0.33 cm⁻¹. The filter element may have a volume of between about 30 cm³ and 600 cm³. According to a preferred embodiment, the filter element is a cylinder with a facial surface area of about 46 cm² and a thickness of about 2.5 cm, with a volume of 115 cm³ and a ratio of thickness to facial surface area of 0.045 cm⁻¹.

A filter element according to an embodiment of the disclosure provides a flux of effluent through the filter element between about 1.5 ml/min/cm² and 50 ml/min/cm² with a pressure drop of less than about 10 psi. According to a preferred embodiment, the filter element provides a flux greater than about 3 ml/min/cm² with a pressure drop less than about 5 psi.

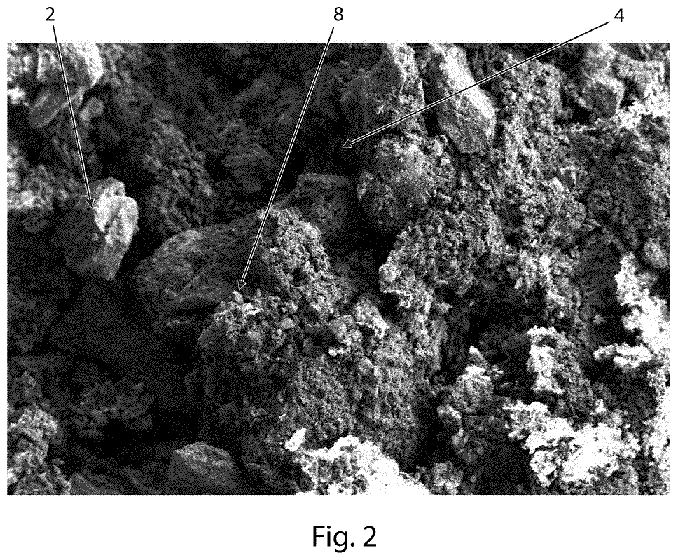

FIG. 2 shows a photomicrograph of a filter element formed according to an embodiment of the disclosure. Larger particle size material 2 form voids 4 between adjacent particles. Smaller particle size material 8 is adhered to the surfaces of the larger particle size material 2. Voids 4 allow water to flow through the element. Smaller particle size material along the inside surfaces of the voids contact the flowing water. Contaminants are attracted to surfaces of the smaller and larger particle size material 2, 8. According to one embodiment of the disclosure, the surfaces of one or both of materials 2 and 8 are activated to provide chemical sites for bonding with contaminants to remove the contaminants from the water. According to a further embodiment, materials 2, 8 are porous.

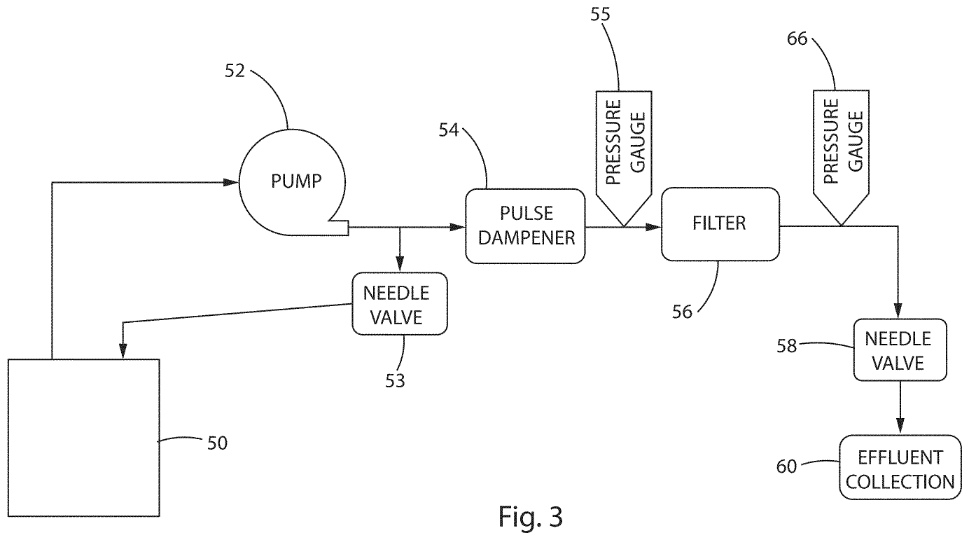

FIG. 3 shows a test bed constructed to test filter elements created according to embodiments of the present disclosure. A raw water reservoir 50 was connected with a diaphragm pump 52. A pulse dampener 54 was connected with the output of pump 52. A needle valve 53 was provided to divert some of the flow of water from the pump back to reservoir 50. A filter 56, that may include a filter element made according to an embodiment of the disclosure was connected with the output of pulse dampener 54. Pressure gauges 55 and 66 were provided at the inlet and outlet of filter 56. An outlet needle valve 58 was connected with the outlet of filter 56. Outlet needle valve 58 drained into effluent container 60.

In operation, the pump 52 was energized and needle valves 53 and 58 were adjusted to provide a desired flow rate through the filter. Pressure drop across the filter was monitored by gauges 55 and 66.

### Example 1

A filter element was created with about 50% large size filter particles and 50% small filter particles without using the process illustrated in FIG. 1. The smaller particle size material, fine lignite powder, HYDRODARCO® M, was obtained from Cabot Norit Americas, Inc. The powder was analyzed by the manufacturer and had a particle size of 100×325 mesh, with above 90% by weight of particles smaller than 325 mesh with a D50 of approximately 15 microns. The larger particle size material, granulated Lignite 3000, also obtained from Cabot Norit Americas, Inc. The material was analyzed by the manufacturer to have a mean particle size (D50) of about 310 microns.

About 36 grams of the fine lignite powder was mixed with 36 grams of the granular lignite and with about 13 grams of a binder, granular UHMWPE, Product No. GUR-2122 made by Celanese Corporation was added. The mixture was blended to create a uniform mixture. A cylindrical mold was provided with a diameter of about 3″ (7.62 cm) and a height of about 1″ (2.54 cm) when the mold was fully closed. Thus, the mold has a volume of about 115.8 cm³. About 81 grams of the mixture was placed in the mold and pressure was applied to the lid of the mold to compact the mixture to conform to the mold shape. The mold was heated to about 150 C to melt the binder particles. The mold was opened and the finished filter element was removed. The finished element has a density of about 0.7 g/cm³ and a surface area of about 45.6 cm² across the face of the element.

### Example 2

A filter element according to an embodiment of the disclosure was created with the same mixture of about 50% the large size filter particles and about 50% small filter particles as in Example 1. First, as discussed in regard to FIG. 1, a gluing solution was formed by combining a non-thermoplastic adhesive material with a solvent. The adhesive material was chitosan powder manufactured by Hard Eight Nutrition, LLC d/b/a/BulkSupplements.com and 20% by weight poly-diallyl dimethyl ammonium chloride (p-DADMAC), Product CS91 manufactured by Kemira Oyj. The solvent was formic acid and water. The gluing solution was prepared by mixing 35 grams of Chitosan powder and 25 ml of the p-DADMAC solution with 450 ml reverse osmosis filtered, deionized (RO/DI) water and 25 ml of the formic acid. The mixture was placed in a container on hot plate equipped with a magnetic stirrer. A magnetic stirring bar was put in the container and used to stir the mixture. The mixture was heated to about 50 C and stirred for about 24 hours until all of the Chitosan powder was observed to have dissolved. The finished gluing solution was cooled to room temperature.

About 250 grams of the fine lignite powder, HYDRODARCO® M was mixed with 250 grams of the Lignite 3000 granules in a stand mixer. The mixer was equipped with a heated mixing bowl. About 500 grams of the gluing solution discussed above was added to the bowl and the mixer was energized to mix the materials and form a paste. The bowl heater was set to about 105C and the mixture was allowed to dry while being agitate for about 90 minutes. As the solvent was removed and as the formic acid decomposed, the paste reverted to granules. The granules were placed in an oven at about 105 C and allowed to dry for several hours.

Approximately 69 grams of the granular material mixed with approximately 13 grams of the same binder as in Example 1, that is, Ultra High Molecular Weight Polyethylene resin pellets. The mixture was placed in the cylindrical mold as in Example 1. The mold was closed and compression was while the mold was heated to about 180 C. The molded material was allowed to cool, solidifying the binder, and adhering the granules with one another to create a filter element with an open-spaced structure. The resulting filter element has a density of 0.596 grams/cm³ and a surface area of 45.6 cm² across the face of the filter element.

### Example 3

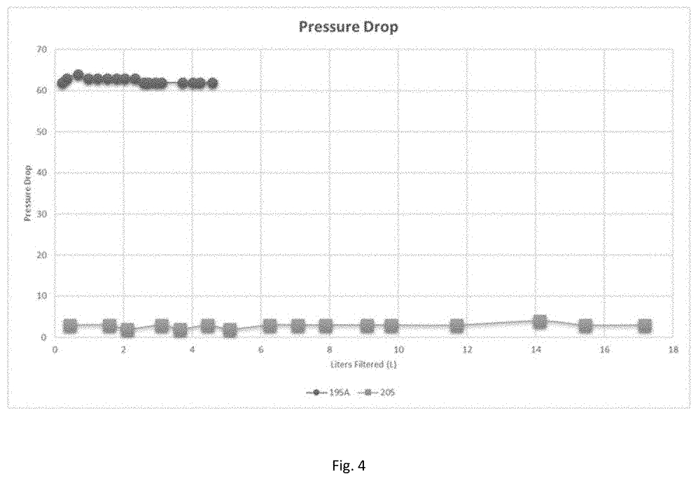

Filter elements created in Examples 1 and 2 were each subjected to flow of water using the apparatus shown in FIG. 3 and as described above. FIG. 4 shows the pressure drop measured across the filter elements. The filter element created in Example 1, made without the process disclosed with respect to FIG. 1, is labeled “195A.” The element created in Example 2, formed using a gluing solution according to embodiments of the disclosure, is labeled “205.” The element formed in Example 1, where small and large particle size material were not glued had a pressure drop of about 60 psi. The flow of water through the filter was about 70 ml/min. The element had a facial surface area of 45.6 cm² and so the flux through the element was 1.53 ml/min/cm².

The filter element created in Example 2, on the other hand, exhibited a very low pressure drop, of between about 2 and 4 psi. The flow through the filter element of Example 2 was about 144 ml/min and thus has a flux of about 3.16 ml/min/cm².

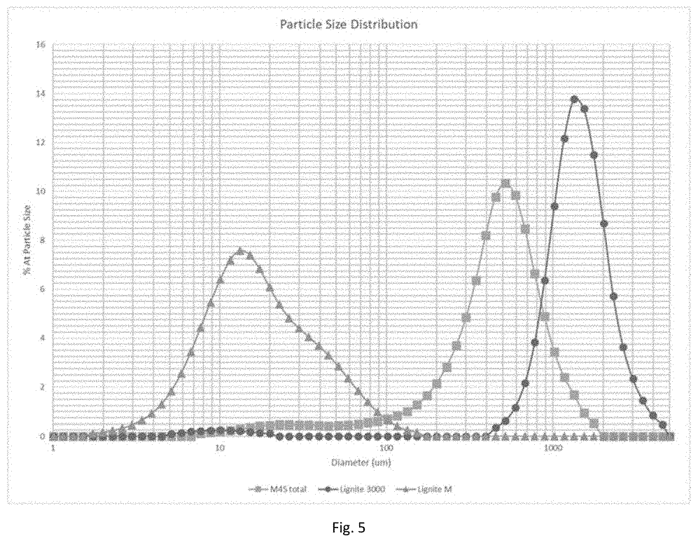

FIG. 5 shows an analysis of the particle size distribution of smaller particle size material, “Lignite M” and larger particle size material “Lignite 3000” used to form the filter elements in Examples 1 and 2. Analysis was done using a Partica LA-960 Laser Scattering Particle Size Distribution Analyzer. The smaller particle size material has a peak in particle size around 10 microns and the larger particle size material has a peak in particle size around 1500 microns. The larger particle size material has a mean particle size about 150 times that of the smaller particle size material.

FIG. 5 also shows the particle size analysis of the filter material made with the Lignite M and Lignite 3000 materials using the process illustrated with respect to FIG. 1. This data is labeled “M45” in FIG. 5.

Surprisingly, when the smaller particle size material is adhered to the surfaces of the larger particle size material, the resulting structure has a single peak particle size. These results show that almost the entirety of the smaller particle size material is adhered to the surfaces of the larger particle size material. Also, the peak size of the joined particles, at around 500 microns, is somewhat less than the size of the larger particle size material, which may be due to attrition of the larger particle size material during processing. Thus, in the filter material prepared using a process according to embodiments of the disclosure has larger particles that are about 50 times larger than the smaller particle size material, with a mean particle size around 10 microns.

While illustrative embodiments of the disclosure have been described and illustrated above, it should be understood that these are exemplary of the disclosure and are not to be considered as limiting. Additions, deletions, substitutions, and other modifications can be made without departing from the spirit or scope of the disclosure. Accordingly, the disclosure is not to be considered as limited by the foregoing description.

We claim:

1. A method for forming a filter comprising the steps of:
providing first filter media particles having a first mean particle size;
providing second filter media particles having a second mean particle size, wherein the second mean particle size is larger than the first mean particle size;
forming a gluing solution, wherein the gluing solution comprises a vehicle, a non-thermoplastic adhesive, and a solubilizing agent;
mixing second filter media particles with the first filter media particles and the gluing solution to form a filter media mixture;
blending the gluing solution and filter media mixture to form a media blend;
drying the blend, wherein a substantial portion of the vehicle is evaporated from the media blend; and
decomposing the agent, wherein the non-thermoplastic adhesive binds the first filter media particles to surfaces of the second filter media particles.

2. The method of claim 1, wherein the solubilizing agent enhances dissolution of the non-thermoplastic adhesive in the vehicle.

3. The method of claim 1, wherein the non-thermoplastic adhesive further comprises an adjunct that creates a negative electric charge when saturated with water.

4. The method of claim 3, wherein the non-thermoplastic adhesive comprises one or more of polyvinylamine, poly(N-methylvinylamine), polyallylamine, polyallyldimethylamine, polydiallylmethylamine, polyvinylpyridinium chloride, poly (2-vinylpyridine), poly(4-vinylpyridine), polyvinylimidazole, poly(4-aminomethylstyrene), poly(4-aminostyrene), polyvinyl(acrylamide-co-dimethylaminopropylacrylamide), polyvinyl(acrylamide-co-dimethylaminoethylmethacrylate), polyethyleneimine, polylysine, poly diallyl dimethyl ammonium chloride (pDADMAC), poly(propylene)imine dendrimer (DAB-Am) and Poly(amidoamine) (PAMAM) dendrimers, polyaminoamides, polyhexamethylenebiguandide, polydimethylamine-epichlorohydrine, aminopropyltriethoxysilane, N-(2-aminoethyl)-3-aminopropyltrimethoxysilane, N-trimethoxysilylpropyl-N,N,N-trimethylammonium chloride, bis(trimethoxysilylpropyl)amine, chitosan, grafted starch, the product of alkylation of polyethyleneimine by methylchloride, the product of alkylation of polyaminoamides with epichlorohydrine, cationic polyacrylamide with cationic monomers, and combinations thereof.

5. The method of claim 1, wherein the vehicle comprises one or more of water, methanol, ethanol, n-propanol, n-butanol, acetone, ethyl acetate, methyl acetate, dimethyl sulfoxide, acetonitrile, dimethylformamide, chloroform, and combinations thereof.

6. The method of claim 1, wherein the solubilizing agent comprises one or more of hydrochloric acid, sulfuric acid, nitric acid, phosphoric acid, tartaric acid, acetic acid, formic acid, propionic acid, ascorbic acid, glutamic acid, lactic acid, maleic acid, malic acid, succinic acid, carboxylic acid, and combinations thereof.

7. The method of claim 1, wherein one or more of the steps of drying and decomposing comprise exposing the blend to an elevated temperature while agitating the blend, wherein the blend forms a flowable blend.

8. The method of claim 1, wherein one or more of the steps of drying and decomposing are performed while the blend is stationary to form a solid mass, and further comprises granulating the mass by one or more of crushing, grinding, or sieving to form a flowable blend.

9. The method of claim 1, wherein the first filter media particles comprise lignite, anthracite, bituminous coal, peat, carbonized wood organic material including bamboo, coconut husk, and animal bone, zeolite including analcime, leucite, pollucite, wairakite, clinoptilolite, barrerite, chabazite, phillipsite, amicite, and gobbinsite, calcium compound including monocalcium phosphate, dicalcium phosphate, monetite, brushite, tricalcium phosphate, whitlockite, octacalcium phosphate, dicalcium diphosphate, calcium triphosphate, hydroxyapatite, apatite, tetracalcium phosphate, diatomaceous earth, silicon compounds including glass, expanded glass, pumice, ceramic material including alumina, bauxite, magnesia, titanium dioxide, and combinations thereof.

10. The method of claim 1, wherein the second filter media particles comprise lignite, anthracite, bituminous coal, peat, carbonized wood organic material including bamboo, coconut husk, and animal bone, zeolite including analcime, leucite, pollucite, wairakite, clinoptilolite, barrerite, chabazite, phillipsite, amicite, and gobbinsite, calcium compound including monocalcium phosphate, dicalcium phosphate, monetite, brushite, tricalcium phosphate, whitlockite, octacalcium phosphate, dicalcium diphosphate, calcium triphosphate, hydroxyapatite, apatite, tetracalcium phosphate, diatomaceous earth silicon compounds including glass, expanded glass, pumice, ceramic material including alumina, bauxite, magnesia, titanium dioxide, and combinations thereof.

11. The method of claim 1, wherein the first mean particle size is between about 1 and about 75 um.

12. The method of claim 1, wherein the second mean particle size is between about 75 and about 3000 um.

13. The method of claim 1, wherein the first filter media particles and second filter media particles are porous and have a total porosity greater than about 0.5 cc/g.

14. The method of claim 1, wherein greater than 40% of the total porosity is provided by pores with a pore size greater than about 5 nanometers.

15. The method of claim 1, further comprising:
providing a binder;
mixing the flowable blend with the binder; and
forming the flowable blend and binder into a solid filter element.
